(19) United States
(12) Patent Application Publication
(10) Pub. No.: US 2006/0256064 A1
(43) Pub. Date: Nov. 16, 2006

(54) Liquid crystal display device

(75) Inventor: Tomoo Miwa, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/433,406

(22) Filed: May 15, 2006

(30) Foreign Application Priority Data
May 16, 2005 (JP) 2005-142167

(51) Int. Cl. G09G 3/36

(52) U.S. Cl. 345/98

(57) ABSTRACT

A liquid crystal display is constituted with a liquid crystal panel holding a liquid crystal layer with an active matrix substrate and a counter substrate, and a backlight unit for lighting the liquid crystal panel. A variable resistor for flickering adjustment is mounted in direct, or an FPC connecting and fixing. The variable resistor is mounted with the pressure-welding to a circuit region where a drive circuit and a voltage generating circuit are mounted in the periphery of the active matrix substrate.

### BACKGROUND OF THE INVENTION

1. Field of the Invention

The present invention relates to a liquid crystal display and particularly to a peripheral structure of a substrate constituting a part of the liquid crystal display.

2. Description of the Related Art

With technical developments in recent years, a liquid crystal display used for a large-screen notebook personal computer has been put into practical use. A liquid crystal layer of this liquid crystal display is usually driven with alternating current (AC) and realizes display of data through supply of positive and negative voltages in every constant period to pixel electrodes and a common voltage to a counter electrode opposite the pixel electrodes.

Here, it is desirable that the voltage applied to the liquid crystal layer is symmetrical in positive and negative voltage waveforms. However, ideal voltage is not applied due to deviation of the common voltage and impurity or the like in liquid crystal cells and, accordingly, a different effective voltage is impressed in the positive and negative voltages. Therefore, difference in the light transmittance when the positive and negative voltages are applied to the pixel electrodes will result in variation of luminance in the period of AC voltage, followed by occurrence of flickering in display image.

In order to suppress flicker phenomenon explained above, for example, the Japanese Laid-Open Patent No. 2002-091393 discloses the method for mounting a first voltage control and a second voltage control to adjust flickering to a printed circuit board provided in the periphery of a liquid crystal panel. The document teaches to conduct fine adjustment with the second volume control after conducting coarse adjustment with the first volume control, while observing a degree of flickering generated in the display image.

In the liquid crystal display described in the above related art, a structure is introduced to locate, in the same plane, the printed circuit board connected with TCP (Tape Carrier Package) and display screen (glass plane) for adjustment of variable resistance during observing the flickering. Therefore, the liquid crystal display explained above has a problem that a size of bezel region of the liquid crystal display becomes large because of the printed circuit board. Accordingly, it becomes difficult to enlarge the display screen of the liquid crystal display.

Meanwhile, it is also considered to employ a structure for arranging the printed circuit board mounting a variable resistance at the rear of the liquid crystal display in view of realizing narrow bezel region of display screen. However, a problem also rises in this case. Namely, in the structure where a variable resistor is located at the rear surface of the liquid crystal display, such variable resistor cannot be confirmed from a viewing surface side and thereby adjustment of the variable resistor while observing flickering display becomes difficult. Moreover, an operator adjusting variable resistance is easy to break the variable resistor by a variable resistance adjusting rod because of the difficulty in the adjustment.

### SUMMARY OF THE INVENTION

Accordingly, an exemplary feature of the invention is to provide a liquid crystal display which can improve workability in adjustment of flickering, while a narrow bezel is realized.

In order to achieve the above exemplary feature, a liquid crystal display of the present invention, comprises an active matrix substrate having a first area and a second area, the second area located on a periphery of the first area, switching elements arranged in a matrix within the first area, a counter substrate located opposite the active matrix substrate and overlapping the first area of the active matrix substrate and not overlapping the second area of the active matrix substrate, a liquid crystal layer sandwiched between the first area of the active matrix substrate and the counter substrate, a circuit region arranged in the second area of the active matrix substrate, the circuit region including operating circuits to operate the switching elements, and a variable resistor mounted on the second area of the active matrix substrate, the variable resistor operatively connected to the operating circuits for making display flickering adjustments.

Another liquid crystal display of the present invention, comprises a liquid crystal panel having an active matrix substrate on which switching elements are arranged in a matrix, a counter substrate located opposite the active matrix substrate, and a liquid crystal layer sandwiched between the active matrix substrate and the counter substrate, wherein, a total front surface area of the active matrix substrate is greater than a total area of the counter substrate, the counter substrate overlaps a first front surface area of the active matrix substrate and does not overlap a second front surface area of the active matrix substrate that is in a peripheral area of the active matrix substrate adjacent the first front surface area, a circuit region is arranged in second front surface area and includes i) a circuit to operate the switching elements, and ii) a flexible board carrying a variable resistor for display flickering adjustment.

It is preferable that the variable resistor is connected to the flexible board by a pressure-welding terminal, and the flexible board is pressure-bonded to second front surface area of the active matrix substrate.

It is preferable that a plurality of terminals is pressure-welded on plural sides of the flexible board. Moreover, it is preferable that all terminals are pressure-welded on a single side of the flexible board.

As explained above, since a variable resistor for flickering adjustment or a flexible board carrying the variable resistor is directly mounted on the active matrix substrate forming the liquid crystal display, a narrower bezel of the liquid crystal display can be realized in comparison with the structure that the variable resistor for flickering adjustment is mounted on the printed circuit board. Moreover, workability of flickering adjustment can be improved and risk of breakdown of the variable resistor may be lowered in comparison with the structure to mount the variable resistor for flickering adjustment to the rear surface of the liquid crystal display.

The liquid crystal display of the present invention is capable of performing the following exemplary advantages.

The first exemplary advantage is to attain a narrower bezel of the liquid crystal display. The reason is that the variable resistor for flickering adjustment is directly mounted on the active matrix substrate.

The second exemplary advantage of the present invention is to reduce risk of breakdown of the variable resistor by improving workability of flickering adjustment. The reason is that the variable resistor for flickering adjustment is mounted to the location ensuring manipulation from the side of viewing surface on the liquid crystal display and thereby the variable resistor can be adjusted while observing the display screen.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1A is a plan view schematically observed from the side of viewing surface of a liquid crystal panel of an exemplary embodiment of the present invention,

FIG. 1B is a cross-sectional view along the line IB-IB in FIG. 1A;

FIG. 2 is a plan view schematically showing a state where a front surface frame is mounted to a liquid crystal display panel as the exemplary embodiment of the present invention;

FIG. 3 is a plan view schematically showing a first embodiment of a variable resistor member mounted on the liquid crystal display panel of the present invention; and

FIG. 4 is a plan view schematically showing a second embodiment of a variable resistor member mounted on the liquid crystal display panel of the present invention.

### DETAILED DESCRIPTION OF THE PREFERRED EMBODIMENTS

The present invention relates, in the preferred embodiments thereof, to a liquid crystal display constituted with a liquid crystal panel formed of an active matrix substrate, a counter substrate, and liquid crystal layer sandwiched between the substrates, and a back light unit for lighting the liquid crystal panel. In this liquid crystal display, a variable resistor for adjusting flickering, or a flexible board carrying the variable resistor for adjusting flickering is directly mounted on a circuit region arranged in the periphery of the active matrix substrate where drive circuits and voltage generating circuits or the like are provided. Flickering adjustment work while observing the display screen can be simplified and breakdown risk of the variable resistor can be reduced by directly mounting the variable resistor on the active matrix substrate.

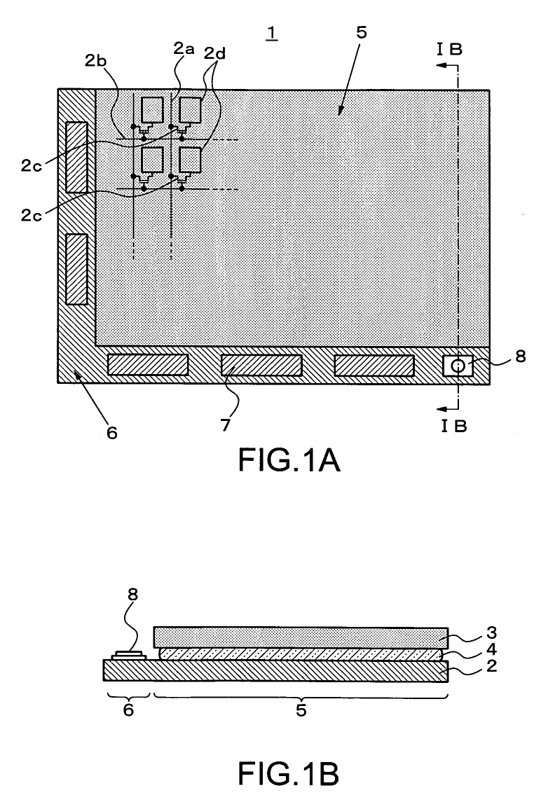

The liquid crystal display of the exemplary embodiment of the present invention will be explained with reference to FIGS. 1A, 1B to FIG. 3. A liquid crystal display is generally constituted with a liquid crystal panel for displaying information, a backlight unit for lighting the liquid crystal panel from the rear surface, and a housing (front surface frame or the like) for holding and fixing the liquid crystal panel and backlight unit.

As shown in FIG. 1B, the liquid crystal panel is constituted with an active matrix substrate 2, a counter substrate 3, and a liquid crystal layer 4 sandwiched between these substrates. As shown in FIG. 1A, a plurality of signal lines 2a and a plurality of scanning lines 2b are formed on the active matrix substrate 2 to cross each other. Switching elements 2c such as thin film transistors (TFTs) are located at the areas near the intersecting points of the signal lines 2a and the scanning lines 2b. Pixel electrodes 2d are located in pixel regions surrounded by the signal lines 2a and scanning lines 2b. Moreover, color filter layers, a black matrix layer, and a counter electrode are formed on the counter substrate.

Moreover, as shown in FIGS. 1A and 1B, the liquid crystal panel 1 is constituted with a display region 5 and a circuit region 6 around the display region 5. In the display region 5, the active matrix substrate 2 and the counter substrate 3 overlap each other. The switching elements 2c are arranged in the display region 5. In the circuit region 6, which is a portion of left side and lower side of the display region 5 in the figure, drive circuits such as a horizontal driver circuit and a vertical driver circuit and various circuits 7 such as a voltage generating circuit for applying voltages to the counter electrode are located. The circuit region 6 is arranged in a peripheral area of the active matrix substrate 2. A circuit to operate the switching elements 2c is located in the circuit region 6.

In the liquid crystal panel of the above-mentioned related art, the drive circuit and voltage generating circuit have been formed on the printed circuit board, the liquid crystal panel and the printed circuit board have been connected with a TCP, and the variable resistor for flickering adjustment has been located on this printed circuit board. Therefore, there has been a problem that a size of the bezel increases when the active matrix substrate and the printed circuit board are located on the same surface, and adjustment of variable resistor while observing the display image becomes difficult when the printed circuit board is located in the rear surface of the liquid crystal panel.

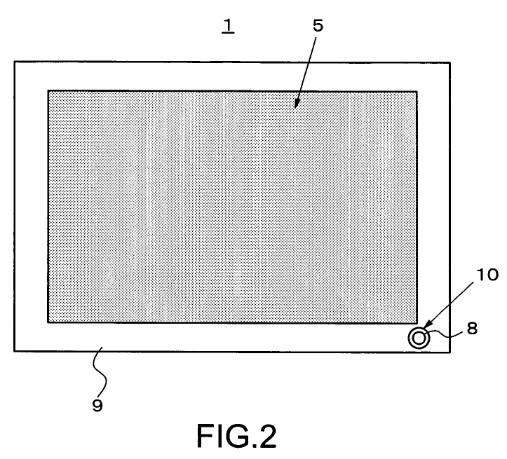

In contrast to the above-mentioned related art, in this embodiment of the invention, the liquid crystal display of this embodiment has realized a narrow bezel by mounting the variable resistor 8 for flickering adjustment to a vacant space of the circuit region 6 of a substrate constituting a part of the liquid crystal panel (preferably, the active matrix substrate 2) as illustrated in FIG. 1A. Moreover, as illustrated in FIG. 2, an aperture 10 is provided to the location corresponding to the variable resistor 8 of a housing (front surface of the frame 9) for fixing the liquid crystal panel 1 to enable manipulation of the variable resistor 8 from the viewing side under the assembled state. Thereby, flickering adjustment work can be simplified.

Structures of FIG. 1A, FIG. 1B, and FIG. 2 are examples and it is enough when adjustment of the variable resistor is possible under the states that the variable resistor 8 is mounted to the circuit region 6 and the liquid crystal panel 1 is held and fixed with the housing. Accordingly, shape, size, location of the circuit 7 and variable resistor 8 within the circuit region 6, mounting structure of the variable resistor 8, and shape, size, and location of the aperture 10 provided at the front surface frame 9 may be modified as required.

Next, a specific manufacturing method of the liquid crystal display of this embodiment will then be explained. First, an active matrix substrate 2 and a counter substrate 3 are formed with the well known method. In this case, the circuits such as a drive circuit and a voltage generating circuit are formed in a circuit region 6 of the active matrix substrate 2 and wiring for connecting the variable resistor 8 and the circuit 7 is formed in a part where the variable resistor 8 for flickering adjustment will be mounted at the following process. Thereafter, a seal material (not illustrated) is provided around a display region 5 of the active matrix substrate 2 or the counter substrate 3 with the well known method. Space between the active matrix substrate 2 and the counter substrate 3 is filled with a liquid crystal layer 4 by vacuum injection method or one-drop fill (ODF) method of liquid crystal material.

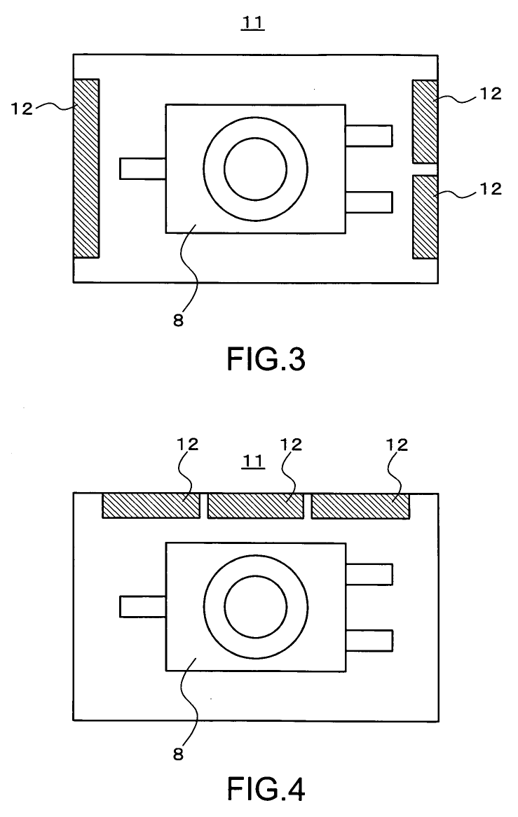

Next, the variable resistor 8 for flickering adjustment is mounted to the circuit region 6 in the periphery of the active matrix substrate 2. This variable resistor 8 may be solely mounted directly to the circuit region 6 but it is also possible to mount the flexible board such as FPC (Flexible Printed Circuit) connecting and fixing the variable resistor to the circuit region 6. For example, as shown in FIG. 3, it is also allowable to employ the structure that the variable resistor 8 is connected and fixed on the FPC 11 forming a pressure-welding terminal 12 at both end surfaces thereof, the variable resistor 8 and pressure-welding terminal 12 are connected in the FPC 11 with a wiring (not illustrated) provided previously, and the pressure-welding terminal 12 of the FPC 11 is pressure-bonded to the wiring of the circuit region 6. A plurality of terminals 12 for pressure-welding are formed in a plurality of sides of the FPC 11. Use of pressure-welding explained above enables easier mounting of the variable resistor 8 on the substrate.

As explained above, the liquid crystal display of this embodiment can provide the merit that since the variable resistor 8 for flickering adjustment is mounted, for manipulation from the viewing side, to the circuit region 6 in the periphery of the substrate (preferably, the active matrix substrate 2) constituting a part of the liquid crystal panel 1, the variable resistor 8 can be easily and reliably adjusted by observing the flickering display, while narrower bezel is realized.

Shape and location of the pressure-welding terminal 12 are not limited with the structure of FIG. 3. Moreover, in the structure of FIG. 3, the FPC 11 mounting the variable resistor 8 is pressure-bonded to the circuit region 6 of the active matrix substrate 2. However, the variable resistor 8 may also be mounted with the other method. For example, the FPC 11 mounting the variable resistor 8 may be mounted to the circuit region 6 of the active matrix substrate 2 with anisotropic conductive bonding material instead of the pressure-welding method.

In the structure of the embodiment explained above, the FPC 11 mounting the variable resistor 8 in FIG. 3 is pressure-bonded with the pressure-welding terminals 12 formed at both end surfaces thereof. However, arrangement of the pressure-welding terminal 12 for pressure welding the FPC 11 mounting the variable resistor 8 is not limited in the structure of FIG. 3. For example, the pressure-welding terminal 12 may be formed only to desired one side, as shown in FIG. 4. In other word, a plurality of terminals 12 for pressure-welding are formed in only one side of the FPC 11. Particularly, a pressure-welding head used in the pressure-welding process can be solely constituted by setting the pressure-welding head in the same direction as a COG (Chip On Glass). COG technology is a method that the driver IC chips such as horizontal driver ICs or vertical driver ICs are directly mounted on the active matrix substrate.

In the liquid crystal display of this embodiment, as explained above, the FPC 11 mounting the variable resistor 8 can be mounted in the same process as COG chips. Therefore, the manufacturing processes can be simplified and manufacturing cost can be reduced. Even in this embodiment, shape of the liquid crystal panel 1, mounting location of the variable resistor 8, shape of the variable resistor 8, and shape of the pressure-welding terminal 12 may be changed as required.

In addition, only one variable resistor 8 is mounted for flickering adjustment in each embodiment explained above. However, the present invention is not restricted to the embodiments explained above and is capable of mounting a plurality of variable resistors 8. Moreover, in each embodiment explained above, the liquid crystal display of the vertical electric field system has been explained, in which the liquid crystal layer 4 is driven with the pixel electrodes formed to the active matrix substrate 2 and the counter electrodes formed to the counter substrate 3. However, the present invention can also be applied to the liquid crystal display of the horizontal electric field system, in which the liquid crystal layer 4 is driven with the electrodes formed to the active matrix substrate 2.

Moreover, the variable resistor for flickering adjustment is mounted into the circuit region in the periphery of the board in each embodiment explained above. However, it is also considered possible to employ the structures that a variable resistor for adjusting the light of backlight unit is mounted, a variable resistor for color adjustment of a display monitor comprising the liquid crystal display as a module is mounted, or a variable resistor for controlling sound volume of a speaker of display monitor is mounted. In addition, it is also considered to mount a variable resistor for the purpose other than flickering adjustment to the circuit region in the periphery of the board and then guiding the same to an external circuit.

The present invention can widely be applied to the liquid crystal display and distinctive advantages can be attained specifically for the liquid crystal display which is required to achieve the narrower bezel for application into a television receiver, a notebook personal computer, and a PC monitor, or the like.

Although preferred embodiments of the invention have been described with reference to the drawings, it will be obvious to those skilled in the art that various changes or modifications may be made without departing from the true scope of the invention.

What is claimed is:

1. A liquid crystal display comprising:
an active matrix substrate having a first area and a second area, the second area located on a periphery of the first area;
switching elements arranged in a matrix within the first area;
a counter substrate located opposite the active matrix substrate and overlapping the first area of the active matrix substrate and not overlapping the second area of the active matrix substrate;
a liquid crystal layer sandwiched between the first area of the active matrix substrate and the counter substrate;
a circuit region arranged in the second area of the active matrix substrate, the circuit region including operating circuits to operate the switching elements; and
a variable resistor mounted on the second area of the active matrix substrate, the variable resistor operatively connected to the operating circuits for making display flickering adjustments.

2. A liquid crystal display comprising:
a liquid crystal panel having an active matrix substrate on which switching elements are arranged in a matrix, a counter substrate located opposite the active matrix substrate, and a liquid crystal layer sandwiched between the active matrix substrate and the counter substrate, wherein,
a total front surface area of the active matrix substrate is greater than a total area of the counter substrate,
the counter substrate overlaps a first front surface area of the active matrix substrate and does not overlap a second front surface area of the active matrix substrate that is in a peripheral area of the active matrix substrate adjacent the first front surface area,
a circuit region is arranged in second front surface area and includes i) a circuit to operate the switching elements, and ii) a flexible board carrying a variable resistor for display flickering adjustment.

3. The liquid crystal display as claimed in claim 2, wherein the variable resistor is connected to the flexible board by a pressure-welding terminal, and the flexible board is pressure-bonded to second front surface area of the active matrix substrate.

4. The liquid crystal display according to claim 3, wherein a plurality of terminals is pressure-welded on plural sides of the flexible board.

5. The liquid crystal display according to claim 3, wherein all terminals are pressure-welded on a single side of the flexible board.
